(19) United States
(12) Patent Application Publication
(10) Pub. No.: US 2002/0128061 A1
(43) Pub. Date: Sep. 12, 2002

(54) Method and apparatus for restricting access to content in a gaming system

(76) Inventor: Victor Keith Blanco, Bothell, WA (US)

Correspondence Address: LEE & HAYES PLLC, 421 W RIVERSIDE AVENUE SUITE 500, SPOKANE, WA, 99201

(21) Appl. No.: 09/802,504

(22) Filed: Mar. 9, 2001

(51) Int. Cl. A63F 13/00

(52) U.S. Cl. 463/29

(57) ABSTRACT

A parental control mechanism for a gaming system restricts the playing or display of various types of content. The parental control mechanism allows a user to restrict access to game content, audio content, video content, and online content through the use of one or more parental control settings. Different types of content can have different parental control settings restricting access to the content. A password associated with the parental control settings prevents unauthorized modification of the settings.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This invention relates to gaming systems and, more particularly, to restricting access to various types of media content in a gaming system.

### BACKGROUND

Gaming systems that are currently available on the market are capable of playing game discs, music CDs, and movie DVDs from a disc drive. For example, the Playstation® 2 gaming system from Sony Corporation provides the ability to play games, music, and video titles from a disc inserted in the console. These gaming systems are designed to play whatever title is in the disc drive. Although these gaming systems are capable of playing game discs, music CDs, and movie DVDs, the gaming systems do not provide a parental control mechanism to restrict the content displayed or executed by the gaming system. Although a user (such as a parent) can attempt to control the content played by the gaming system by controlling the media titles purchased for the system, the gaming systems themselves do not provide a mechanism for restricting the playing of inappropriate content purchased by someone else (e.g., a friend's game, CD, or DVD). Thus, the currently available gaming systems cannot restrict the content displayed once a disc has been installed in the gaming system. This situation places the burden on the parent or guardian to ensure that discs containing inappropriate content are not installed in the gaming system.

Current gaming systems also provide access to online sources through, for example, a modem contained in the game console. These gaming systems allow access to any online data and do not provide any parental control mechanism to restrict the types of online data retrieved and displayed by the gaming system. Instead, the parent or guardian must monitor the online data accessed by the gaming system or disable the online capabilities of the gaming system (e.g., by removing or disabling the modem).

Accordingly, there is a need for an improved mechanism for restricting access to content in a gaming system that supports various media types and online content.

### SUMMARY

The method and apparatus described herein provides the ability to restrict access to various types of content in a gaming system. A parental control mechanism allows the restriction of game content, audio content, video content, and online content through the use of one or more parental control settings. The parental control mechanism is applied to all content installed in the gaming system, regardless of the source of the content. For example, a particular game may execute in one gaming system, but not execute on another system due to different parental control settings associated with the different gaming systems.

In the described implementation, the gaming system includes a game console and one or more controllers. The game console is equipped with a hard disk drive, a portable media drive, and broadband connectivity. A console application stored on the hard disk drive is loaded when the game console is powered on. The console application presents a menu hierarchy that includes various parental control setting menus for restricting access to different types of content supported by the gaming system.

Separate parental control settings can be established for each type of content supported by the gaming system. Thus, a particular type of content may have a certain level of restriction while a different type of content has a different level of restriction. For example, the gaming system can be configured to play any music CD, but restrict game content to games that are appropriate for teenagers. A password associated with the parental control settings prevents unauthorized modification of the settings.

### BRIEF DESCRIPTION OF THIE DRAWINGS

FIG. 1 illustrates a gaming system that restricts access to content based on parental control settings.

FIG. 2 is a block diagram of the gaming system.

FIG. 3 illustrates a network gaming system in which the FIG. 1 gaming system is connected via a network to other consoles and services.

FIG. 4 illustrates a navigation design employed by the gaming system.

FIG. 5 illustrates a graphical user interface depicting the main menu of the gaming system.

FIG. 6 is a flow diagram of the general operation that is executed after the system initialization processes are completed.

FIG. 7 illustrates a graphical user interface depicting the settings collection menu.

FIG. 8 is a flow diagram illustrating the selection of various settings menus.

FIG. 9 illustrates a graphical user interface depicting the parental control settings menu.

FIG. 10 is a flow diagram illustrating the setting of various parental control parameters.

FIG. 11 is a flow diagram illustrating the application of parental control settings in a gaming system.

### DETAILED DESCRIPTION

The method and apparatus described herein relates to restricting access to various content in a gaming system. Access can be restricted to game content, audio content, video content, and online content. Separate control settings can be established for each different type of content. The control settings are stored in a game console such that the settings are applied to all content accessed or received by the game console. A password is associated with the parental control settings to prevent unauthorized changes to the settings.

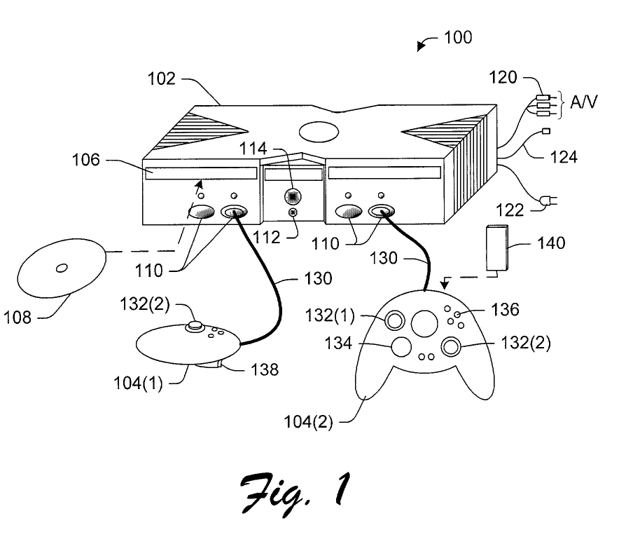

FIG. 1 shows an exemplary gaming system 100. It includes a game console 102 and up to four controllers, as represented by controllers 104(1) and 104(2). The game console 102 is equipped with an internal hard disk drive and a portable media drive 106 that supports various forms of portable storage media as represented by optical storage disc 108. Examples of suitable portable storage media include DVD, CD-ROM, game discs, and so forth.

The game console 102 has four slots 110 on its front face to support up to four controllers, although the number and arrangement of slots may be modified. A power button 112 and an eject button 114 are also positioned on the front face of the game console 102. The power button 112 switches power to the game console and the eject button 114 alternately opens and closes a tray of the portable media drive 106 to allow insertion and extraction of the storage disc 108.

The game console 102 connects to a television or other display (not shown) via A/V interfacing cables 120. A power cable 122 provides power to the game console. The game console 102 may further be configured with broadband capabilities, as represented by the cable or modem connector 124 to facilitate access to a network, such as the Internet.

Each controller 104 is coupled to the game console 102 via a wire or wireless interface. In the illustrated implementation, the controllers are USB (Universal Serial Bus) compatible and are connected to the console 102 via serial cables 130. The controller 102 may be equipped with any of a wide variety of user interaction mechanisms. As illustrated in FIG. 1, each controller 104 is equipped with two thumbsticks 132(1) and 132(2), a D-pad 134, buttons 136, and two triggers 138. These mechanisms are merely representative, and other known gaming mechanisms may be substituted for or added to those shown in FIG. 1.

A memory unit (MU) 140 may be inserted into the controller 104 to provide additional and portable storage. Memory units 140 enable users to store game parameters and port them for play on other consoles. In the described implementation, each controller 104 is configured to accommodate two memory units 140, although more or less than two units may be employed in other implementations.

The gaming system 100 is capable of playing, for example, games, music, and videos. With the different storage offerings, titles can be played from the hard disk drive or the portable medium 108 in drive 106, from an online source, or from a memory unit 140. A sample of what the gaming system 100 is capable of playing back include:

1. Game titles played from CD and DVD, from the hard disk drive, or from an online source.

2. Digital music played from a CD in the portable media drive 106, from a file on the hard disk drive (e.g., Windows Media Audio (WMA) format), or from online streaming sources.

3. Digital audio/video played from a DVD disc in the portable media drive 106, from a file on the hard disk drive (e.g., Active Streaming Format), or from online streaming sources.

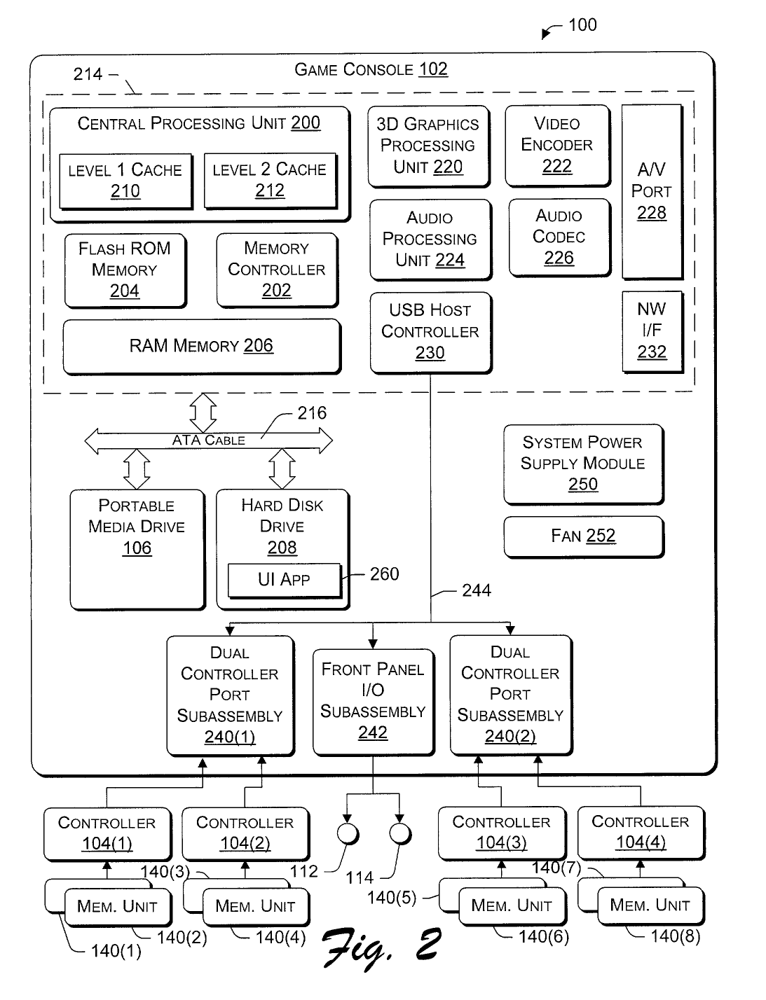

FIG. 2 shows functional components of the gaming system 100 in more detail. The game console 102 has a central processing unit (CPU) 200 and a memory controller 202 that facilitates processor access to various types of memory, including a flash ROM (Read Only Memory) 204, a RAM (Random Access Memory) 206, a hard disk drive 208, and the portable media drive 106. The CPU 200 is equipped with a level 1 cache 210 and a level 2 cache 212 to temporarily store data and hence reduce the number of memory access cycles, thereby improving processing speed and throughput.

The CPU 200, memory controller 202, and various memory devices are interconnected via one or more buses, including serial and parallel buses, a memory bus, a peripheral bus, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also s known as a Mezzanine bus.

As one suitable implementation, the CPU 200, memory controller 202, ROM 204, and RAM 206 are integrated onto a common module 214. In this implementation, ROM 204 is configured as a flash ROM that is connected to the memory controller 202 via a PCI (Peripheral Component Interconnect) bus and a ROM bus (neither of which are shown). RAM 206 is configured as multiple DDR SDRAM (Double Data Rate Synchronous Dynamic RAM) that are independently controlled by the memory controller 202 via separate buses (not shown). The hard disk drive 208 and portable media drive 106 are connected to the memory controller via the PCI bus and an ATA (AT Attachment) bus 216.

A 3D graphics processing unit 220 and a video encoder 222 form a video processing pipeline for high speed and high resolution graphics processing. Data is carried from the graphics processing unit 220 to the video encoder 222 via a digital video bus (not shown). An audio processing unit 224 and an audio codec (coder/decoder) 226 form a corresponding audio processing pipeline with high fidelity and stereo processing. Audio data is carried between the audio processing unit 224 and the audio codec 226 via a communication link (not shown). The video and audio processing pipelines output data to an A/V (audio/video) port 228 for transmission to the television or other display. In the illustrated implementation, the video and audio processing components 220-228 are mounted on the module 214.

Also implemented on the module 214 are a USB host controller 230 and a network interface 232. The USB host controller 230 is coupled to the CPU 200 and the memory controller 202 via a bus (e.g., PCI bus) and serves as host for the peripheral controllers 104(1)-104(4). The network interface 232 provides access to a network (e.g., Internet, home network, etc.) and may be any of a wide variety of various wired or wireless interface components including an Ethernet card, a modem, a Bluetooth module, a cable modem, and the like.

The game console 102 has two dual controller support subassemblies 240(1) and 240(2), with each subassembly supporting two game controllers 104(1)-104(4). A front panel I/O subassembly 242 supports the functionality of the power button 112 and the eject button 114, as well as any LEDs (light emitting diodes) or other indicators exposed on the outer surface of the game console. The subassemblies 240(1), 240(2), and 242 are coupled to the module 214 via one or more cable assemblies 244.

Eight memory units 140(1)-140(8) are illustrated as being connectable to the four controllers 104(1)-104(4), i.e., two memory units for each controller. Each memory unit 140 offers additional storage on which games, game parameters, and other data may be stored. When inserted into a controller, the memory unit 140 can be accessed by the memory controller 202.

A system power supply module 250 provides power to the components of the gaming system 100. A fan 252 cools the circuitry within the game console 102.

The game console 102 implements a uniform media portal model that provides a consistent user interface and navigation hierarchy to move users through various entertainment areas—gaming, movies, and music. The game console 102 restricts access to various types of content based on one or more parental control settings established using the hierarchy and procedures discussed herein.

To implement the uniform media portal model and the content access restrictions, a console user interface (UI) application 260 is stored on the hard disk drive 208. When the game console is powered on, various portions of the console application 260 are loaded into RAM 206 and/or caches 210, 212 and executed on the CPU 200. The console application 260 presents a graphical user interface that provides a consistent user experience when navigating to different entertainment areas and distinguishes between available media and media types on the game console. The console application 260 includes the various user interfaces used to define and implement the parental control features discussed herein. In alternate implementations, the parental control features are defined and implemented by a separate parental control application stored on the hard disk drive 208.

The gaming system 100 may be operated as a standalone system by simply connecting the system to a television or other display. In this state, the gaming system 100 allows one or more players to play games, watch movies, or listen to music. However, with the integration of broadband connectivity made available through the network interface 232, the gaming system 100 may further be operated as a participant in a larger network gaming community. This network gaming environment is described next.

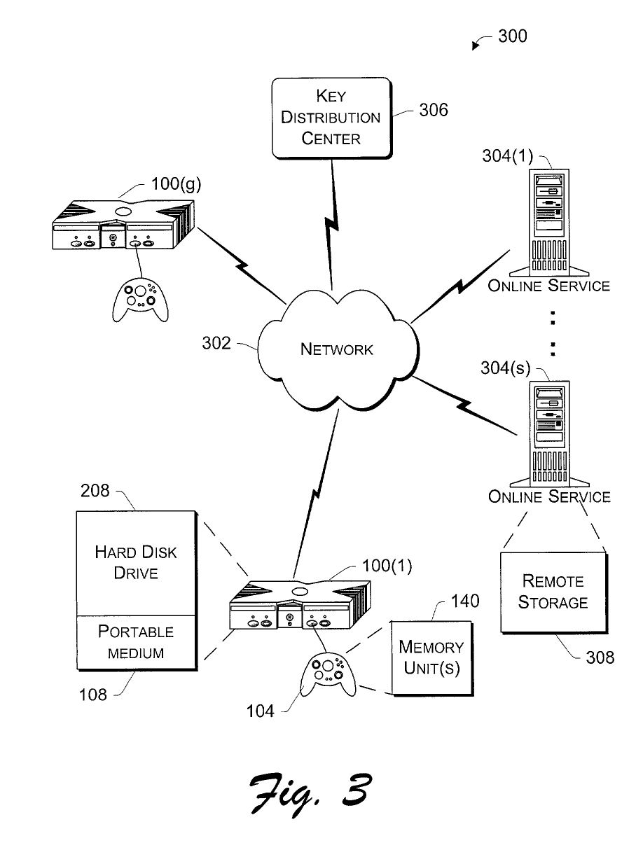

FIG. 3 shows an exemplary network gaming environment 300 that interconnects multiple gaming systems 100(1), . . . , 100(g) via a network 302. The network 302 represents any of a wide variety of data communications networks. It may include public portions (e.g., the Internet) as well as private portions (e.g., a residential Local Area Network (LAN)), as well as combinations of public and private portions. Network 302 may be implemented using any one or more of a wide variety of conventional communications media including both wired and wireless media. Any of a wide variety of communications protocols can be used to communicate data via network 302, including both public and proprietary protocols. Examples of such protocols include TCP/IP, IPX/SPX, NetBEUI, etc.

In addition to gaming systems 100, one or more online services 304(1), 304(s) may be accessible via the network 302 to provide various services for the participants, such as hosting online games, serving downloadable music or video files, hosting gaming competitions, serving streaming audio/video files, and the like. The network gaming environment 300 may further involve a key distribution center 306 that plays a role in authenticating individual players and/or gaming systems 100 to one another as well as online services 304. The distribution center 306 distributes keys and service tickets to valid participants that may then be used to form games amongst multiple players or to purchase services from the online services 304.

The network gaming environment 300 introduces another memory source available to individual gaming systems 100—online storage. In addition to the portable storage medium 108, the hard disk drive 208, and the memory unit(s) 140, the gaming system 100(1) can also access data files available at remote storage locations via the network 302, as exemplified by remote storage 308 at online service 304(s).

Restrictions on access to certain content can be enforced against any content received through the network gaming environment. For example, based on the parental control settings of a particular gaming system 100(1), certain content (game content, music content, or video content) received from network 302 is not executed by or displayed on gaming system 100(1).

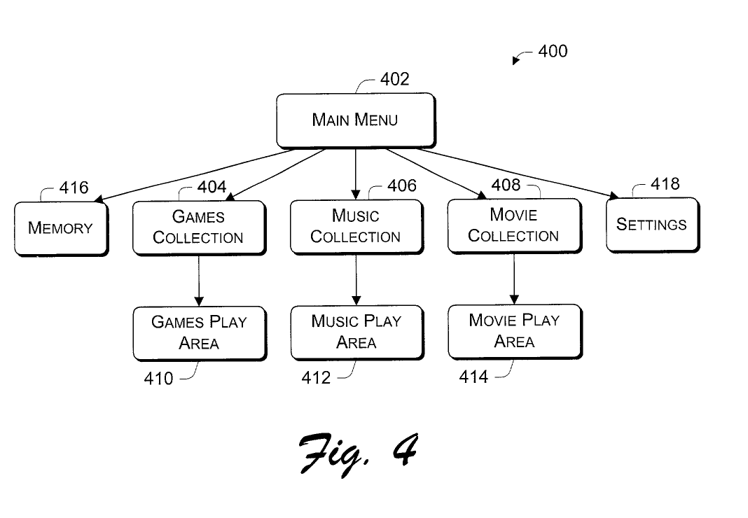

FIGS. 4 shows the uniform media portal model 400. It provides main menu 402 that acts as a common interface for multiple entertainment areas, including games, movies, music, and game system settings. The main menu 402 presents the user with a set of navigation choices that accurately describe what they would like to interact with on their console.

Beneath the main menu 402 are collections of titles that pertain to their particular entertainment areas and are currently available to the user. In this example, a user can navigate from the main menu 402 to a games collection 404 that lists currently available game titles. Navigation may also be made to a music collection 406 that groups available music titles and a movie collection 408 that groups available movie titles. Beneath each collection is the specific play area that pertains to the particular media experience. A games play area 410 is navigated through the games collection 404, a music play area 412 is accessed through the music collection 406, and a movies play area 414 is navigated through the movie collection 404. This model thus provides a high-level “filter” on the kinds of media available on the console, and what operations may be performed with respect to the media.

The model 400 also accommodates system areas, including a memory area 416 and a settings area 418. The memory area 416 allows users to manage the available memory devices in the console. The settings area 418 allows users to preview and adjust various game console options, such as clock settings, language settings, video settings, audio settings, and parental control settings.

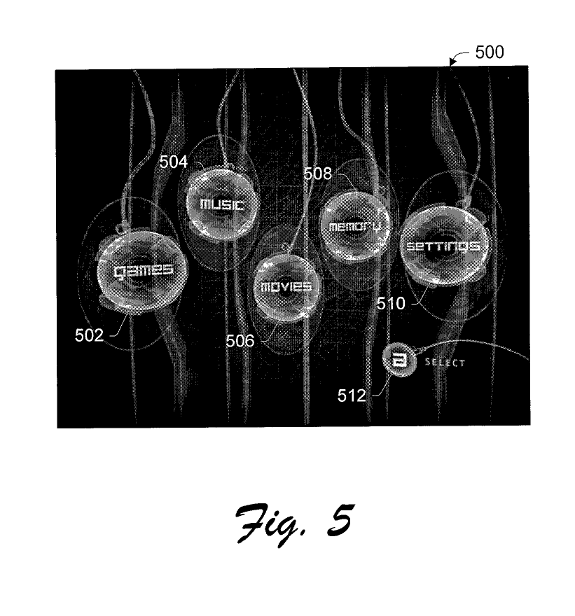

FIG. 5 illustrates an exemplary graphical user interface 500 that can be presented as the main menu 402 of the uniform media portal model 400. The main menu UI 500 is generated by the console UI application 260 and depicted on the television or other display. The main menu UI 500 contains the five menu elements: a games element 502, a music element 504, a movies element 506, a memory element 508, and a settings element 510. These elements provide the navigation entry points for the five level-one areas of the uniform media portal model 400, namely, the games collection 404, the music collection 406, the movie collection 408, the memory 416, and the settings 418. Any of the four controllers 104(1)-104(4) may be used to navigate the console user interface.

A select element 512 allows the user to select the focused element from among the five main menu elements 502-510. The “A” button on the controller is used to control the select element 512, and hence the graphical select element 512 illustrates an “a” within the element. Upon selection, the console UI application navigates to the selected area.

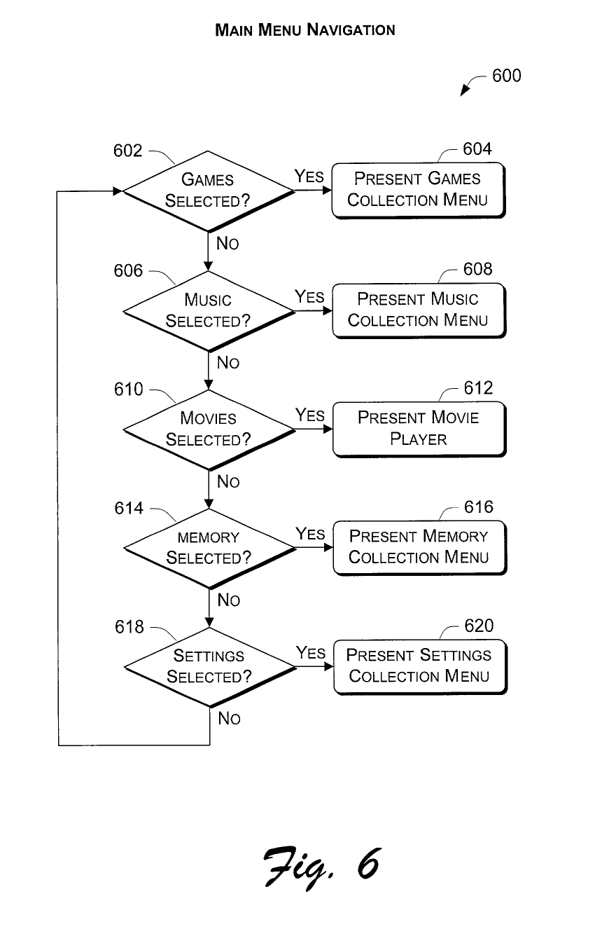

FIG. 6 illustrates the main menu navigation process 600 in more detail. The process 600 is implemented in software as computer-executable instructions that are executed by the CPU 200 to perform the operations illustrated as blocks. The process generally discerns which element is selected and navigates to the selected area. At block 602, the console UI application 260 determines whether the games element 502 is selected. If so (i.e., the “Yes” branch from block 602), the console UI application 260 navigates to the games collection 404 and presents a games collection menu (block 604). Similarly, at block 606, the console UI application 260 determines whether the music element 504 has been selected. If so, the console UI application 260 navigates to the music collection 406 and presents a music collection menu (block 608). At block 610, the console UI application 260 determines whether the movies element 506 was selected. If so, the console UI application 260 navigates to the movie collection 408 and presents a movie player (block 612). At block 614, the console UI application 260 determines whether the memory element 508 has been selected. If so, the console UI application 260 ;navigates to the memory area 416 and presents a memory collection menu (block 616). Finally, at block 618, the console UI application 260 determines whether the settings element 510 was selected. If so, the console UI application 260 navigates to the settings area 418 and presents a settings collection menu (block 620).

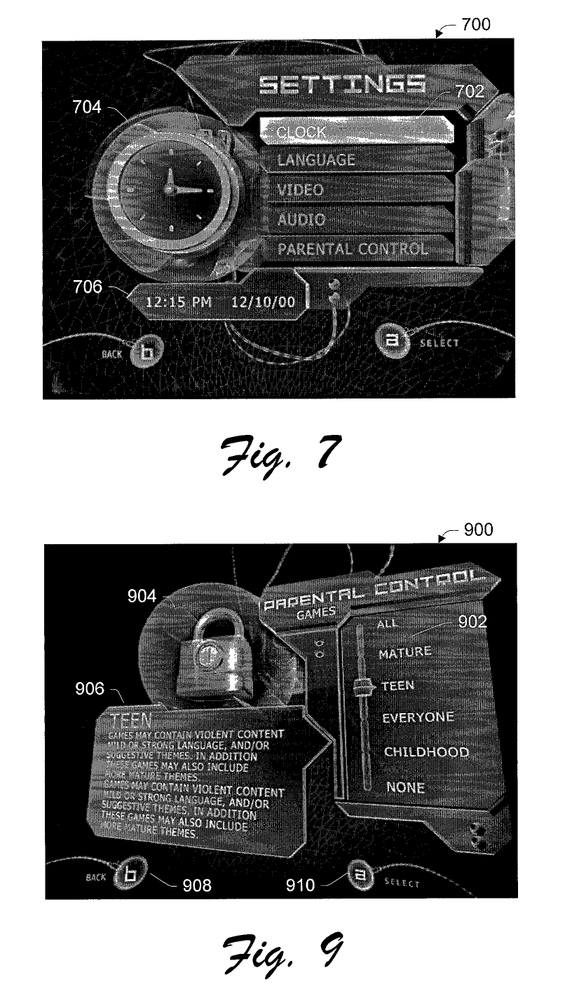

FIG. 7 illustrates an exemplary settings collection menu 700 that is presented upon selection of the settings element 510 in main menu 500 (FIG. 5). The settings collection menu 700 provides a preview of currently set options and mechanisms for adjusting the settings. The settings collection menu 700 includes a list 702 of the available settings, an orb 704 containing an image of the currently selected setting, and a preview panel 706 for displaying the currently set value of the setting.

In the illustrated example, the available settings include:

Clock—The date and time are displayed in the preview panel.

Language—The currently set language is displayed in the preview panel.

Audio—The audio connection information is displayed in the preview panel.

Video—The video format information is displayed in the preview panel.

Parental Control—A small sentence noting if parental controls are enabled is displayed in the preview panel.

The settings collection menu 700 is designed to behave as a view on the currently set values. The user can navigate through the list 702 by using the up and down directions of the thumbstick (or other directions or mechanism). By selecting an element from the settings menu, the user is taken to another menu to adjust the value.

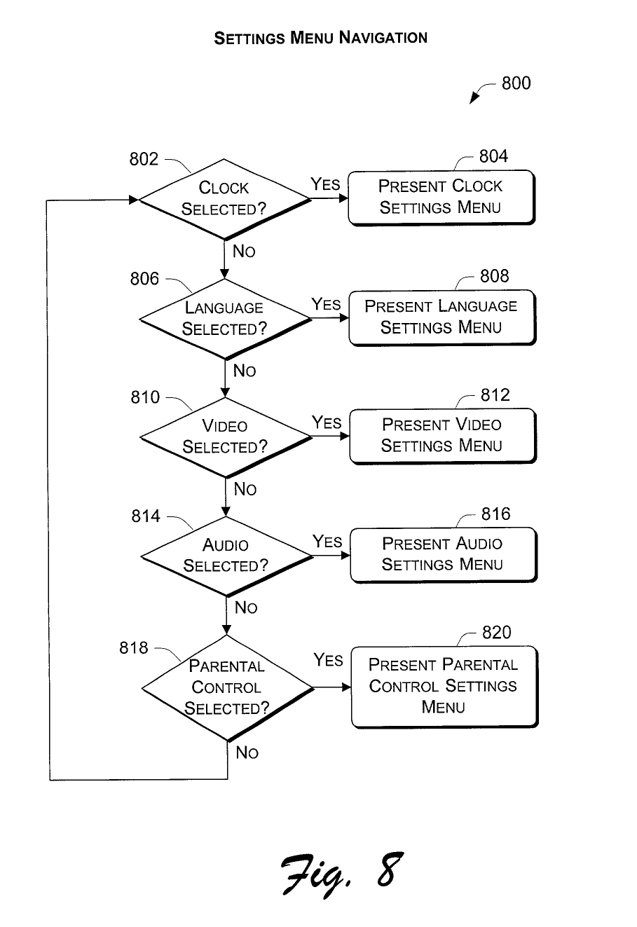

FIG. 8 is a flow diagram illustrating a menu navigation process 800 for selecting various settings menus. The process 800 is implemented in software as computer-readable instructions that are executed by the CPU 200 to perform the operations illustrated as blocks. In general, the process 800 determines which setting parameter has been selected and displays the appropriate settings menu to the user of the gaming system. At block 802, the process determines whether the clock setting has been selected. If so, the process presents a clock settings menu to the user of the gaming system (block 804). Continuing at block 806, the process 800 determines whether the language setting has been selected. If so, the process presents a language settings menu to the user of the gaming system (block 808). At block 810, the process determines whether the video setting has been selected. If so, the process presents a video settings menu to the user of the gaming system (block 812). Next, at block 814, the process 800 determines whether the audio setting has been selected. If so, the process presents an audio settings menu to the user of the gaming system (block 816). At block 818, the process determines whether the parental control setting has been selected. If so, the process presents a parental control settings menu to the user of the gaming system (block 820).

FIG. 9 illustrates a graphical user interface depicting an exemplary parental control settings menu 900 for game content. The parental control settings menu provides a mechanism for restricting or blocking specific content. The parental control settings menu 900 includes a content filter control 902 that includes a range indicator that identifies a range of different content restriction levels and a control (also referred to as a “slider”) that can be moved to select different levels of filtering (i.e., content restriction) based upon the age-appropriateness of the audience. In FIG. 9, the filter control 902 ranges from filtering “All” content to filtering “None” of the content, with intermittent levels of “Childhood”, “Everyone”, “Teen”, and “Mature”. In this example, the control (or slider) is set at the “Teen” filtering level (i.e., content restriction level). An orb 904 portrays a graphic that indicates whether the filter is set (e.g., a lock) or not.

A metatext panel 906 provides a summary of the filtering that occurs at the corresponding highlighted level. In this example, the panel 906 describes the filter for the “Teen” level. The back button 908 navigates the user back to the settings collection menu 700, canceling any changes that were made. The select button 910 commits the change and the video settings are changed, as the user is navigated back to the settings collection menu 700.

It is noted that the filter levels may change depending upon the media type under review. FIG. 9 shows the parental control options for games. A different set of options may be presented for movies or music. For example, movie filter levels may correspond to a movie rating system, such as G, P, PG-13, and R. In this example, the metatext panel 906 will provide a summary of the movie content for the selected rating. As the user of the gaming system moves the filter control 902 to different movie ratings, the summary in the metatext panel 906 changes to correspond to the currently selected movie rating.

Furthermore, the parental control options may vary for different countries. As an example, different countries may use different rating systems for movies or music. The particular rating system presented to a user of the gaming system is selected based on the country in which the gaming system is used. Thus, the i rating system presented to the user is likely to be familiar to users in the country of use.

In one implementation, the gaming system provides separate parental control settings for game content, audio content, movie content, and online content. These four separate control settings allow a user of the gaming system to customize the control settings based on their own desires.

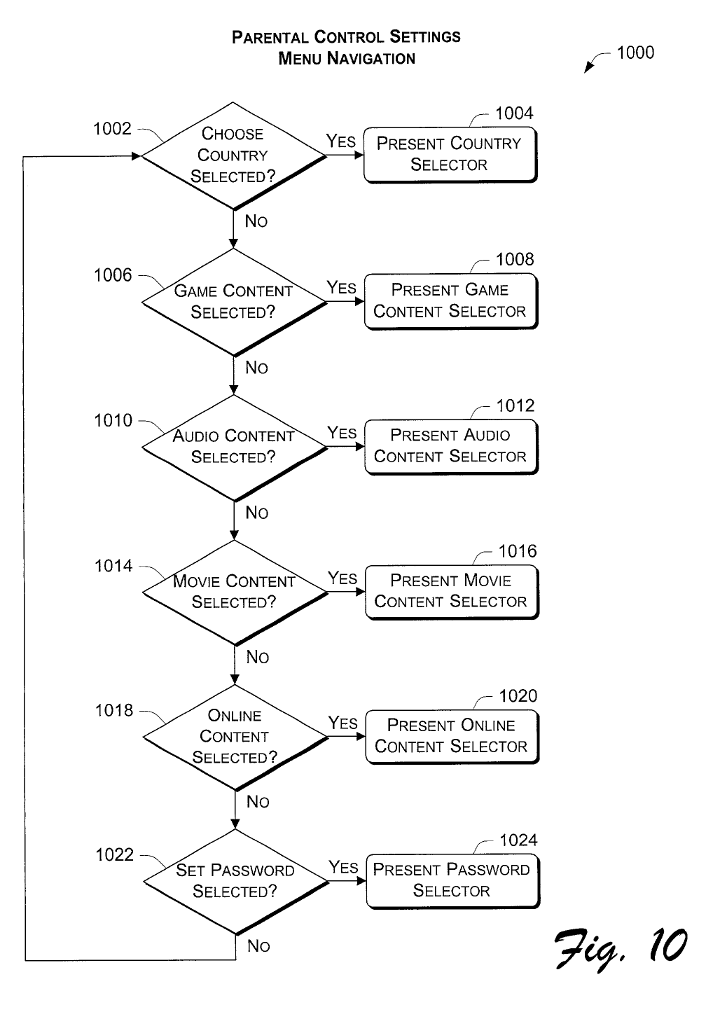

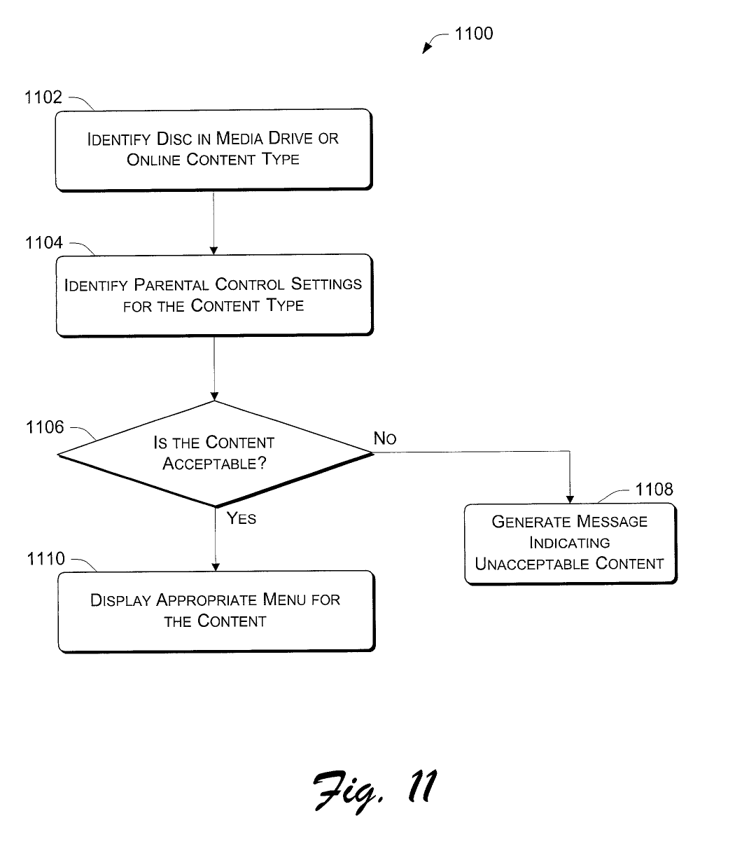

FIG. 10 is a flow diagram illustrating a menu navigation process 1000 for entering various parental control settings. Before changing any parental control settings, the user of the gaming system must enter an acceptable password. This password prevents the unauthorized modification of the parental control settings. In one implementation, the password is entered as a series of four actions (e.g., pressing or moving particular buttons or thumbsticks on the controller 104). The password is stored in the gaming system (e.g., on hard disk drive 208).

The process 1000 is implemented in software as computer-readable instructions that are executed by the CPU 200 to perform the operations illustrated as blocks. Generally, the process 1000 allows the user of the gaming system to identify and modify current parental control settings. In one implementation, the parental control setting options depend on the user's region code and the host country's rules relating to game and movie ratings.

At block 1002, the process 1000 determines whether a country setting option has been selected. If so, the user of the gaming system is presented with a country selector (block 1004). The country selector allows the user to select the country in which the gaming system is being used. In one implementation, the user is presented with a list of countries available for their specific region. For example, in the North America region, the user can choose between ‘U.S.’, ‘Canada’, and ‘Mexico’.

At block 1006, the process determines whether a game content setting is selected. If so, the user of the gaming system is presented with a game content selector (block 1008). The game content selector (such as the content filter control 902 shown in FIG. 9) allows the user to select different levels of game content filtering based upon the age of the audience. If the country in which the user is located does not have a game rating system, an ‘All/None’ option is presented to the user, which allows the user to permit execution of all games or prevent execution of any games on the gaming system.

At block 1010, the process determines whether an audio content setting has been selected. If so, the user of the gaming system is presented with an audio content selector (block 1012). The audio content selector allows the user to select different levels of audio content filtering based upon the age of the listening audience. The audio content selector may use, for example, an existing music rating system that rates the content of pre-recorded music stored on CDs, cassette tapes, or other storage media.

At block 1014, the process determines whether a movie content setting is selected. If so, the user of the gaming system is presented with a movie content selector (block 1016). The movie content selector allows the user to select different levels of movie content filtering based upon the movie viewing audience. For example, a user in the U.S. may select between movie content filtering based on the existing movie rating system: G, PG, PG-13, and R. If the country in which the user is located does not have a movie rating system, an ‘All/None’ option is presented, which allows the user to permit viewing of all movies or prevent viewing of all movies on the gaming system.

At block 1018, the process 1000 determines whether an online content setting is selected. If so, the user of the gaming system is presented with a online content selector (block 1020). The online content selector allows the user to select different levels of filtering for content received from online sources, such as other gaming consoles, servers, and online services.

Finally, at block 1022, the process 1000 determines whether a password setting has been selected. If so, the user of the gaming system is presented with a password selector (block 1024). The password selector allows the user to enter a password (such as a four action password) using the controller 104.

All parental control settings entered by the user are stored in the game console 102. In one implementation, parental control settings are stored on hard disk drive 208. In alternate implementations, the parental control settings are stored on a non-volatile and non-removable memory device in the game console 102. The non-volatile memory device ensures that the settings persist after a power down or system reset. By storing the parental control settings on a non-removable memory device, the settings remain associated with the game console 102. If the settings were stored on a removable memory device, the parental control mechanism could be defeated by removing the memory device.

If the user of the gaming system sets the game, movie, music, and online content to “All”, the user will not be asked to enter a password because all content has been approved for display or execution. In this situation, the parental controls are effectively turned off.

To change one or more existing parental control settings, the user of the gaming system navigates to the parental control settings menu, where the user is asked to enter the password. If the user successfully enters the password, the user is permitted to modify one or more parental control settings and save those changes.

FIG. 11 is a flow diagram illustrating a process 1100 for applying parental control settings in a gaming system. The process 1100 is implemented in software as computer-readable instructions that are executed by the CPU 200 to perform the operations illustrated as blocks. At block 1102, the process 1100 identifies the disc in the media drive (e.g., the type and the rating of the content on the disc) or identifies the online content type and rating. The process then identifies the parental control settings associated with the identified content type. For example, if a game disc is installed in the media drive, the process 1100 identifies the disc as a game disc and identifies the game's rating, if any. Alternatively, if the gaming system is accessing online content, the process identifies the type of content and any rating associated with the online content.

The process 1100 continues at block 1106, which determines whether the content (i.e., the content to be read from a disc or received from an online source) is acceptable based on the relevant parental control settings. If the content is not acceptable (i.e., eliminated by the parental control settings), the process generates a message indicating that the content is not acceptable (block 1108). If the content is acceptable, the process continues to block 1110, which displays the appropriate menu (e.g., game menu, music menu, or movie menu) for the content.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A game console, comprising:
a memory;
a processor; and
a console application stored in memory and executable on the processor, the console application restricting access to content based on a parental control setting.

2. A game console as recited in claim 1 wherein the parental control setting is associated with a particular media type.

3. A game console as recited in claim 1 wherein the parental control setting is associated with a rating system used in a country for which the game console is configured.

4. A game console as recited in claim 1 wherein the console application restricts access to content based on a plurality of parental control settings, each of the plurality of parental control settings is associated with a particular media type.

5. A game console as recited in claim 1 wherein the parental control setting is associated with game content.

6. A game console as recited in claim 1 wherein the parental control setting is associated with audio content.

7. A game console as recited in claim 1 wherein the parental control setting is associated with video content.

8. A game console as recited in claim 1 wherein the parental control setting is associated with online content.

9. A game console as recited in claim 1 wherein the memory comprises a hard disk drive.

10. A game console as recited in claim 1 wherein the console application presents a user interface that allows entry of at least one parental control setting.

11. A game console as recited in claim 1 wherein the console application presents a user interface that allows entry of a game content parental control setting, an audio content parental control setting, a video content parental control setting, and an online content parental control setting.

12. A game console as recited in claim 1 wherein the console application presents a user interface that allows entry of a password associated with at least one parental control setting.

13. A method comprising:
identifying content to be executed on a game console;
identifying a parental control setting;
analyzing the content to be executed on the game console using the parental control setting; and
executing the content on the game console if the content satisfies the parental control setting.

14. A method as recited in claim 13 wherein the content to be executed on the game console is game content.

15. A method as recited in claim 13 wherein the content to be executed on the game console is audio content.

16. A method as recited in claim 13 wherein the content to be executed on the game console is video content.

17. A method as recited in claim 13 wherein analyzing the content includes determining a rating associated with the content and comparing that rating to the parental control setting.

18. A method as recited in claim 13 wherein the parental control setting is associated with the type of content to be executed on the game console.

19. A method as recited in claim 13 wherein identifying the parental control setting includes identifying the parental control setting associated with the type of content to be executed on the game console.

20. A method as recited in claim 13 further including forgoing execution of the content on the game console if the content fails to satisfy the parental control setting.

21. A method as recited in claim 13 further including generating a message indicating unacceptable content if the content does not satisfy the parental control setting.

22. One or more computer-readable media comprising computer-executable instructions that, when executed, perform the method as recited in claim 13.

23. A method comprising:
identifying a type of content to be accessed by a game console;
identifying a parental control setting associated with the type of content to be accessed by the game console;
analyzing the content to be accessed by the game console using the identified parental control setting; and
allowing the game console to access the content if the content satisfies the identified parental control setting.

24. A method as recited in claim 23 wherein the type of content to be accessed by the game console is game data.

25. A method as recited in claim 23 wherein the type of content to be accessed by the game console is audio data.

26. A method as recited in claim 23 wherein the type of content to be accessed by the game console is video data.

27. A method as recited in claim 23 wherein the type of content to be accessed by the game console is online data.

28. One or more computer-readable media comprising computer-executable instructions that, when executed, perform the method as recited in claim 23.

29. A user interface for a game console, comprising:
a main menu configured to identify different media types that may be played by the game console; and
a parental control settings menu accessible from the main menu to allow a user to set various content restrictions for each of the different media types that may be played by the game console.

30. A user interface as recited in claim 29 wherein the different media types that may be played by the game console include a game media type, a music media type, and a movie media type.

31. A user interface as recited in claim 29 wherein the parental control settings menu further allows a user to set a password to prevent unauthorized modification of the parental control settings.

32. A user interface for a game console, comprising:
a range indicator that identifies a range of content restriction levels; and
a control movable relative to the range indicator to select a particular content restriction level.

33. A user interface as recited in claim 32, further comprising a first display region to identify a particular media type that may be played by the game console, the range indicator being adapted to identify ranges of content restriction levels for the media type identified in the first display region.

34. A user interface as recited in claim 32, further comprising a second display region to identify a summary of the content restriction for the currently selected content restriction level.

35. A computer-readable medium for a game console comprising computer-executable instructions that, when executed, cause the game console to:
identify content to be played by the game console;
identify a parental control setting associated with the identified content;
determine whether the identified content satisfies the parental control setting; and
playing the identified content if the identified content satisfies the parental control setting.

36. A computer-readable medium as recited in claim 35 wherein the identified content to be played by the game console is selected from a group of media types comprising game data, audio data, and video data.

37. A computer-readable medium as recited in claim 35 wherein the instructions further cause the game controller to modify the parental content settings after a user enters a valid password associated with the parental content settings.
